(19) United States
(12) Patent Application Publication
(10) Pub. No.: US 2014/0239233 A1
(43) Pub. Date: Aug. 28, 2014

(54) METHOD FOR PRODUCING PRODUCTION GAS AND APPARATUS USING SAME

(71) Applicants: Masayasu Sakai, Nagasaki (JP); Nobuaki Murakami, Nagasaki (JP); Akira Hasegawa, Nagasaki (JP)

(72) Inventors: Masayasu Sakai, Nagasaki (JP); Nobuaki Murakami, Nagasaki (JP); Akira Hasegawa, Nagasaki (JP)

(21) Appl. No.: 14/127,559

(22) PCT Filed: Jun. 4, 2012
(86) PCT No.: PCT/JP2012/064396

§ 371 Date: May 12, 2014

(30) Foreign Application Priority Data
Jun. 22, 2011 (JP) 2011-138966

(51) Int. Cl. C01B 3/02

(52) U.S. Cl. CPC C01B 3/02
USPC 252/373; 422/198

(57) ABSTRACT

Provided is a method for producing a production gas and an apparatus using the same with which a load may be increased in biomass treatment and the quality of the production gas may be improved. According to the present invention, a raw material fluid (F2) containing a biomass (M1) is supplied from an upstream end (22a) toward a downstream end (22b) in a raw material passage (22) separated from the outside by a reaction tube wall (21), and the raw fluid (F2) of the raw material passage (22) is heated from the outer side of the raw material passage (22) through the reaction tube wall (21) by a first heating means (F1). The raw material passage (22) comprises a first gasification region (23) where a first gasification reaction occurs in which at least part of the biomass is gasified by heating conducted by the first heating means (F1), and a second gasification area (25) disposed closer to the downstream end (22b) than to the first gasification region (23). Additional heating of the raw material fluid (F2) is conducted by a second heating means (30) at the second gasification region (25).

### TECHNICAL FIELD

The present application relates to a gasification technique of reforming biomass to gas fuel in a gas form having high convenience, and a technique of producing, from biomass, synthesis gas to be used as a raw material for chemical synthesis of methanol, gas to liquid (GTL) fuel (fuel equivalent to petroleum), or the like.

### BACKGROUND ART

Hitherto, heat obtained by direct burning has been mainly used for energy conversion of solid biomass such as herbaceous plants, woody plants and the like. In this case, sophisticated use of energy is difficult. For example, in the case of power generation, a power generation system is generally used in which water vapor is generated by a wood chip boiler and power is generated by a water vapor turbine. However, the fact is that power generation efficiency is at most 8 to 12%, when power is generated on a scale of 1,000 to 3,000 kW. Power output cannot be obtained on a small scale of 100 kW. Currently, a gasification technique for high-efficiency use of energy of biomass from a small scale to a large scale has been developed. This development mainly deals with a partial oxidation method involving semi-burning of biomass in the presence of a theoretical amount or less of air or oxygen. According to the partial oxidation method, a great amount of soot and tar is generated, and further a considerable amount of CO₂ (a greater amount of nitrogen in the case of using air) used for generating heat is mixed in production gas (synthesis gas). Thus, it has been difficult to obtain synthesis gas of high quality.

For the purpose of sophisticated use of energy of biomass, conversion to liquid fuel is one preferred form from the viewpoint of the use as automobile fuel, the transportation of fuel, and the like. However, under present circumstances, a method for producing liquid fuel from biomass produces, for example, ethanol fuel obtained by fermentation using sugar, starch, or the like as a raw material or biodiesel fuel (BDF®) obtained by transesterifying plant oil with methanol. Thus, the method for producing liquid fuel from biomass uses mainly food as a raw material, and has been put into practical use merely as a procedure using a plant having low yield per cultivation area.

That is, a gasification apparatus capable of converting non-food biomass of herbaceous plants, woody plants and the like to a synthesis gas to be used as a chemical synthesis raw material of high quality by a thermal chemical procedure has not been put into practical use.

In view of the foregoing situation, the inventors of the present application have devised a gasification method capable of converting biomass to fuel for chemical synthesis of high quality with hardly generating tar or soot (JP 2009-001826 A).

That is, the gasification method is a method for gasifying biomass involving supplying biomass made of a pulverized herbaceous plant or woody plant or the like into a gasification space (raw material passage) disconnected (separated) from an external heating space (heating passage) by a reaction tube wall, and heating the biomass through the reaction tube wall from the heating passage to cause a gasification reaction between high-temperature water vapor blown into the raw material passage and biomass in the raw material passage by an endothermic reaction.

According to the above-mentioned method, the generation of free carbon, that is, tar and soot can be suppressed to enhance synthesis gas to a composition appropriate for chemical synthesis by setting a molar ratio of water vapor to biomass, in the case of setting m to 1.3 and n to 0.9 in a simplified molecular formula: CₘH₂Oₙ of the biomass, to 0.3 to 15.

### PRIOR ART DOCUMENT

JP 2009-001826 A

### SUMMARY OF INVENTION

### Technical Problem

The above-mentioned method (JP 2009-001826 A) proposed by the inventors of the present application adopts an external heating system in which a heating source (high-temperature heating fluid such as external heat gas) in a heating passage is prevented from flowing into a raw material passage by separating the raw material passage from the heating passage by a reaction tube wall, and reaction heat to be required for gasifying biomass is supplied from the heating source mainly by heat radiation through the reaction tube wall. Therefore, the problems of the partial oxidation method such as the mixing of CO₂ and the generation of a great amount of soot and tar are solved, and clean and high-caloric gas fuel suitable for a gas engine for power generation can be produced from a biomass resource. Further, the composition of production gas can also be optimized to the composition of synthesis gas to be used as a chemical raw material. Further, according to the above-mentioned method, biomass can be gasified even on a small scale. As a heating source in the method, it is preferred that external heat gas produced by burning combustibles such as biomass be used from the viewpoints of energy efficiency and economy.

The production gas produced by the above-mentioned method can also be used as gas fuel for power generation or heat use, and further can also be used as synthesis gas to be used for liquid fuel synthesis such as methanol synthesis and Fischer-Tropsch (FT) (petroleum properties) synthesis which are existing technologies.

However, as a result of studies by the inventors of the present application, it was revealed that the above-mentioned method has room for improvement in the following points.

Specifically, when it is used as a raw material for synthesis of liquid fuel, it is desired that the content of hydrogen and carbon monoxide (H₂+CO content) be large, and/or a molar ratio of hydrogen to carbon monoxide (H₂/CO ratio) be high. However, it has been difficult to achieve such conditions depending on, for example, the kind and properties of biomass in some cases.

Further, irrespective of whether the production gas is used as gas fuel or synthesis gas, it is desired that the content (molar concentration) of ethylene C₂H₄ or the like in the production gas, which is a cause for soot and tar, be as small as possible. However, according to the above-mentioned method, the content of C₂H₄ becomes high depending on, for example, the kind and properties (composition, particle diameter) of biomass to be used, which causes problems in terms of quality and production steps of synthesis gas in some cases.

The content of H₂+CO in the synthesis gas is preferably 65% or more; the H₂/CO ratio is preferably 1.5 or more, particularly preferably 1.8 or more; and the content of C₂H₄ is preferably 3% or less, particularly preferably 2% or less.

Further, it is important that a sufficient load can be taken (the treatment amount of biomass is increased) in the production of production gas (in particular, synthesis gas). However, it is difficult to achieve both the sufficient load and the enhancement of quality (in particular, the enhancement of quality as synthesis gas) in some cases depending on, for example, the kind and properties of biomass.

For example, in the case where a heating fluid is supplied from a downstream side of a raw material fluid in the method of JP 2009-001826 A, there is an advantage in that it is easy to increase the temperature of the raw material fluid on the downstream side and high-quality (the content of H₂+CO is large, the H₂/CO ratio is high, and/or the content of C₂H₄ is small) production gas can be produced; on the other hand, there is a problem in that it is difficult to sufficiently increase the temperature of the raw material fluid on the upstream side and a sufficient load cannot be taken. In contrast, in the case where the heating fluid is supplied from the upstream side of the raw material fluid, it is easy to increase the temperature of the raw material fluid on the upstream side and a sufficient load can be taken; however, there is a problem in that it is difficult to sufficiently increase the temperature of the raw material fluid on the downstream side, and therefore production gas of high quality cannot be produced.

### Solution to Problem

The present application discloses the followings:

A method for producing production gas, comprising:

supplying a raw material fluid containing biomass from an upstream end side to a downstream end side in a raw material passage separated from outside by a reaction tube wall; and

heating the raw material fluid in the raw material passage by first heating means through the reaction tube wall from outside of the raw material passage,

the raw material passage including a first gasification region for causing a first gasification reaction in which at least part of the biomass is gasified by the heating by the first heating means, and a second gasification region positioned on the downstream end side with respect to the first gasification region,

wherein the raw material fluid is subjected to additional heating by second heating means in the second gasification region.

A method for producing production gas, comprising:

supplying a raw material fluid containing biomass from an upstream end side to a downstream end side in a raw material passage;

supplying a heating fluid from the upstream end side to the downstream end side along the raw material passage in a heating passage separated from the raw material passage by a reaction tube wall; and

heating the raw material fluid by supplying heat of the heating fluid to the raw material fluid in the raw material passage through the reaction tube wall,

wherein the raw material fluid is increased in temperature to 800° C. to 1,000° C. with heat from the heating fluid in a predetermined site of the raw material passage, and

the raw material fluid is increased in temperature to 900° C. to 1,100° C. by performing additional heating through use of second heating means on a downstream side with respect to the predetermined site.

An apparatus for producing production gas, comprising:

a raw material passage which is separated from outside by a reaction tube wall, a raw material fluid containing biomass being supplied from an upstream end side to a downstream end side; and

first heating means,

wherein the raw material fluid in the raw material passage is heated by the first heating means through the reaction tube wall from outside of the raw material passage,

the raw material passage includes a first gasification region for causing a first gasification reaction in which at least part of the biomass is gasified by the heating by the first heating means, and a second gasification region positioned on the downstream end side with respect to the first gasification region, and

the apparatus further comprises second heating means for performing additional heating of the raw material fluid in the second gasification region.

Each of the above-mentioned inventions adopts an external heating system involving supplying a raw material fluid containing biomass to the raw material passage separated from the outside by the reaction tube wall and gasifying the biomass by heating the raw material fluid in the raw material passage through the reaction tube wall. Therefore, unlike a partial oxidation method (method for gasifying biomass with heat obtained by burning the biomass in the raw material passage), clean production gas can be obtained in which the amount of soot and tar to be generated is small.

In addition, at least part of the biomass is gasified by heating by the first heating means in a portion (first gasification region) on the upstream side of the raw material passage, and additional heating is performed by the second heating means in a portion (second gasification region) of the raw material passage positioned on the downstream end side with respect to the first gasification region. Thus, a sufficient load can be taken by appropriately heating the first gasification region with the first heating means, and production gas can be enhanced in quality, the content of H₂+CO in the production gas can be increased, the H₂/CO ratio can be increased, and/or the content of C₂H₄ can be reduced by appropriately heating the second gasification region with the second heating means. In this manner, heating by the first heating means on the upstream side and heating by the second heating means on the downstream side are performed independently in separate stages, and hence both the sufficient load and the enhancement of quality of production gas can be realized easily.

The term “biomass” as used in the present application refers to a resource derived from an organism. Examples of the “biomass” which can be used preferably include solid herbaceous plants, woody plants and the like, for example, trees such as Japanese cedar, pruned branches, bark, Saccharum officinarum, napier grass, and rice straw.

The term “production gas” as used in the present application refers to gas produced by using biomass as a main raw material through the decomposition of biomass, the reaction of the biomass with reaction water, or the like. The “production gas” which is used as fuel is referred to as “gas fuel”, and the “production gas” which is used as a raw material for synthesis of liquid fuel or the like is referred to as “synthesis gas”

The term “fluid” as used in the present application refers to an object having flowability, and gas and a mixture of gas and powder or particles having flowability are included in the “fluid”.

The term “raw material fluid” as used in the present application refers to a fluid containing biomass.

The term “passage” as used in the present application refers to a space in which fluid can be supplied or a space through which a fluid can pass.

In a preferred embodiment, the first heating means is a heating fluid to be supplied from the upstream end side to the downstream end side in the heating passage separated from the raw material passage by the reaction tube wall. In this case, the heating fluid serving as the first heating means is supplied in the same direction as that of the raw material fluid (from the upstream end side to the downstream end side of the raw material fluid). As a result, the upstream end side of the raw material fluid to the first gasification region can be heated efficiently, and a sufficient load can be taken. The term “heating fluid” as used in the present application refers to a fluid to be supplied to the heating passage so as to heat the raw material fluid.

In a preferred embodiment, the heating fluid is gas increased in temperature by burning a combustible. In this case, energy efficiency and economy in the production of the production gas can be improved.

In a preferred embodiment, the first gasification region is contained in the heating passage.

In a preferred embodiment, the additional heating is performed in a plurality of stages at a plurality of positions in the second gasification region. In this case, temperature control for enhancing the quality of the production gas can be performed more precisely.

In a preferred embodiment, a reaction in which a hydrocarbon is decomposed to generate hydrogen proceeds at higher speed or higher efficiency in the second gasification region than in the first gasification region.

In a preferred embodiment, the raw material fluid is heated to 800° C. to 1,000° C. by the first heating means in the first gasification region.

In a preferred embodiment, the raw material fluid is heated to 900° C. to 1,100° C. by the second heating means in the second gasification region.

In a preferred embodiment, the additional heating is performed on the downstream end side with respect to a position where the raw material fluid is increased in temperature to 800° C. or more by the heating by the first heating means.

In a preferred embodiment, the raw material passage includes a discharge port for discharging ash, and the additional heating is performed on the downstream end side with respect to the discharge port.

In a preferred embodiment, the additional heating is performed by burning fuel in the heating passage.

In a preferred embodiment, the additional heating is performed by introducing gas at a predetermined temperature or higher to the heating passage.

In a preferred embodiment, the additional heating is performed by electric heating.

In a preferred embodiment, the raw material fluid is increased in temperature by 100° C. to 300° C. by the additional heating.

In a preferred embodiment, the production gas to be produced contains hydrogen/carbon monoxide in a molar ratio of 1.5 or more.

In a preferred embodiment, the production gas to be produced contains hydrogen and carbon monoxide in a concentration of 65% or more.

In a preferred embodiment, the production gas to be produced contains ethylene in a concentration of 3% or less.

### BRIEF DESCRIPTION OF DRAWINGS

FIG. 1 is an explanatory diagram illustrating an apparatus and method for producing production gas according to a preferred embodiment.

FIG. 2 is an explanatory diagram illustrating an apparatus for producing production gas of a comparative example.

FIG. 3 is an explanatory diagram illustrating an apparatus for producing production gas of a comparative example.

FIG. 4 is an explanatory diagram showing results of an effect verification experiment.

FIG. 5 is an explanatory diagram illustrating an apparatus and method for producing production gas according to a preferred embodiment.

FIG. 6 are explanatory diagrams illustrating an apparatus and method for producing production gas according to a preferred embodiment.

FIG. 7 is an explanatory diagram illustrating an illustrative biomass energy use system including the apparatus for producing production gas according to a preferred embodiment.

### MODES FOR CARRYING OUT THE INVENTION

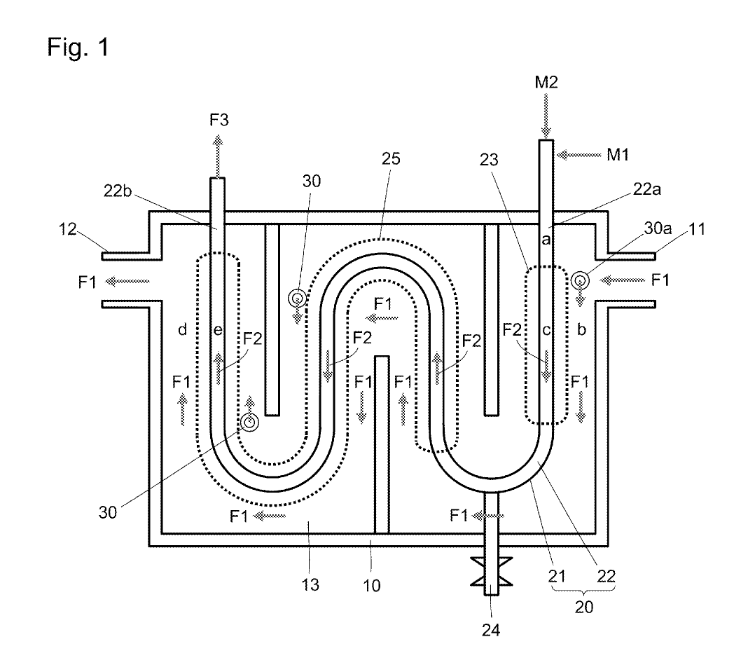

FIG. 1 is an explanatory diagram illustrating an apparatus and method for producing production gas (Example) according to a preferred embodiment.

As illustrated in FIG. 1, the gas production apparatus includes a heating furnace 10 and a reaction tube 20.

The heating furnace 10 includes a heating passage (space) 13 having a predetermined length extending from a supply port 11 to a discharge port 12 and formed of an external wall and a partition wall each made of a fire-resistive material. A heating fluid F1 serving as first heating means is supplied from the supply port 11 and passes through the heating passage 13 to be discharged from the discharge port 12. Although FIG. 1 illustrates the case where one supply port 11 and one discharge port 12 are provided, any one or both of the numbers of the supply ports 11 and discharge ports 12 to be provided can be two or more. As the heating fluid F1, a fluid such as gas heated to an appropriate temperature range by any method can be used, and it is preferred that high-temperature external heat gas F1 obtained by burning biomass be used from the viewpoints of energy efficiency, economy, and the like. The temperature of the external head gas F1 in the vicinity of the supply port 11 is preferably 1,000° C. to 1,250° C., more preferably 1,150° C. to 1,200° C.

The reaction tube 20 is a tubular member having a predetermined length. The sectional shape, length, material, etc. of the reaction tube 20 may be arbitrarily determined. The reaction tube 20 includes a reaction tube wall 21 accommodated in the heating passage 13, and a raw material passage (space) 22 extending from an upstream end 22a to a downstream end 22b is formed in the reaction tube wall 21. Biomass M1 serving as a raw material for producing production gas and reaction water (water vapor) M2 are supplied from the upstream end 22a side, and a raw material fluid F2 formed of a mixture of the biomass M1 and the reaction water M2 passes through the heating passage 13 to be discharged from the downstream end 22b side. It is preferred that the reaction water M2 be supplied to the raw material passage 22 in a pre-heated state. The pre-heating temperature of the reaction water M2 is preferably 400° C. to 900° C., more preferably 450° C. to 750° C. The raw material fluid F2 is changed in composition through reactions such as gasification and decomposition while passing through the raw material passage 22, and the term “raw material fluid” is used throughout the process before and after the change.

The reaction tube wall 21 separates the raw material passage 22 from the heating passage 13, and inflow and outflow of substances (molecules and particles) are cut off between the raw material passage 22 and the heating passage 13. The reaction tube wall 21 can be formed of a heat-conductive material such as a heat-resistive metal, and heat of the heating fluid F1 passing through the heating passage 13 is transmitted to the raw material fluid F2 in the raw material passage 22 by heat conduction or heat radiation through the reaction tube wall 21.

This embodiment adopts a system (forward flow system) in which a passage direction of the heating fluid F1 in the heating passage 13 is set to the same direction as a passage direction of the raw material fluid F2 in the raw material passage 22. Specifically, the supply port 11 is provided at a position closer to the upstream end 22a than to the downstream end 22b, and the discharge port 12 is provided at a position closer to the downstream end 22b than to the upstream end 22a. The heating fluid F1 supplied from the supply port 11 passes through the heating passage 13 along the raw material passage 22 from the upstream end 22a side of the raw material passage 22 to the downstream end 22b side thereof. Thus, a portion of the raw material passage 22 on the upstream end 22a side comes into contact with and is heated by the heating fluid F1 on the upstream end 22a side of the heating fluid F1, and a portion of the raw material passage 22 on the downstream end 22b side comes into contact with the heating fluid F1 on the downstream side of the heating fluid F1.

The raw material fluid F2 supplied from the upstream end 22a is heated with heat from the heating fluid and is gasified by a gasification reaction (primary gasification reaction) F1 at a predetermined portion (primary gasification region 23) on the upstream end 22a side. The biomass can be represented substantially by C_{1.3}H₂O_{0.9} based on a content ratio of C, H, and O serving as main constituent elements thereof, and almost all the amounts of organic components excluding ash of the biomass are converted into gas containing [H₂, CO, CH₄, C₂H₄, CO₂] as main components by an endothermic reaction with water vapor. The composition of gas to be produced is hardly influenced by the kind (cellulose, hemicellulose, lignin, etc.) of the biomass.

An example of a reaction formula of the primary gasification reaction at a temperature of 800° C. and a normal pressure (0.1 MPa) is shown below Formula 1. The amount of reaction water involved in the reaction, the composition of production gas, the endothermic amount, and the like vary depending on conditions such as reaction temperature, however, a period of time required for completing the primary gasification reaction is very short: 0.5 second at 800° C. to 850° C. and 0.2 second at 850° C. to 900° C.

C_{1.3}H₂O_{0.9}+0.4H₂O→0.8H₂+0.7CO+0.3CH₄+0.02C₂H₄+0.3CO₂−39.7 kcal/mol (Formula 1)

When the primary gasification temperature (temperature of raw material fluid F2 during primary gasification/temperature of raw material fluid F2 in primary gasification region 23) is less than 800° C., the generation amount of soot and smoke increases, which may cause inconveniences such as the clogging of the raw material passage 22 and/or the degradation in quality of production gas F3. Therefore, it is preferred that the primary gasification temperature be 800° C. or more, in particular 830° C. or more.

Most types of biomass generate ash (substance which is in a solid state at room temperature) during gasification (primary gasification), and when the primary gasification temperature is more than 900° C., most types of biomass may cause inconveniences such as the clogging of the raw material passage 22 due to the melting of the ash. In order to prevent the inconveniences even in biomass having a lower ash melting point, it is preferred that the primary gasification temperature be 900° C. or less, in particular, 870° C. or less.

For the above-mentioned reason, it is preferred that the raw material fluid F2 be increased in temperature to 800° C. to 900° C., in particular, 830° C. to 870° C. in the primary gasification region 23.

In primary gasification at 800° C. to 900° C., gas to be produced contains H₂ in a small amount and CO and C₂H₄ in large amounts, compared to gasification at higher temperatures (for example, 1,000° C.). Therefore, under this condition, synthesis gas of high quality cannot be obtained. In this embodiment, the quality of the synthesis gas F3 is enhanced by performing additional heating with second heating means (additional heating means) 30 in a downstream part (secondary gasification region 25) to be described later.

A discharge port 24 for discharging ash generated by gasification continuously or at a certain time interval is provided halfway through the reaction tube 20. Major part of the ash is generated by the primary gasification reaction, and hence it is preferred that the discharge port 24 be provided on a downstream side of the primary gasification region 23. The discharge port 24 is disposed preferably on a downstream side with respect to a position where the raw material fluid F2 supplied from the upstream end 22a is increased in temperature to 800° C., more preferably on a downstream side with respect to a position where the raw material fluid F2 supplied from the upstream end 22a is increased in temperature to 830° C.

In the secondary gasification region 25 positioned on a downstream side with respect to the primary gasification region 23, one or a plurality of the second heating means 30 are disposed.

The secondary heating means 30 is any means for increasing the temperature of the raw material fluid F2 by supplying additional heat to the raw material fluid F2. Specific examples of the second heating means 30 include the following (1) to (3).

(1) A nozzle or the like for blowing gas fuel or liquid fuel into the heating passage 13 is attached, and the raw material fluid F2 is increased in temperature with heat generated by burning the fuel from the nozzle. In the case of using external heat gas generated by burning biomass or the like as the heating fluid F1, by setting the temperature of the external heat gas and the concentration of oxygen at the position of the second heating means 30 to predetermined values or more, gas fuel or liquid fuel can be ignited and burning thereof can be kept merely by blowing the gas fuel or the liquid fuel into the heating passage 13 without using ignition means or a combustion improver such as oxygen separately. The temperature of the external heat gas F1 at the position of the second heating means 30 is preferably 650° C. or more, more preferably 700° C. or more. The content of oxygen of the external heat gas F1 at the position of the second heating means 30 is desirably 1.5% or more, more preferably 2% or more.

(2) A supply port for blowing a high-temperature fluid into the heating passage 13 is provided, and the raw material fluid F2 is increased in temperature with the high-temperature fluid from the supply port. As the high-temperature fluid, the same fluid as the heating fluid F1 such as external heat gas generated by burning biomass or the like can be used, or a fluid such as any gas increased in temperature by any other means can be used. The temperature of the high-temperature fluid to be used in this case is preferably 1,000° C. to 1,250° C., more preferably 1,100° C. to 1,200° C.

(3) The raw material fluid F2 is increased in temperature by electric heating (resistance heating, induction heating). In this case, a conductor for generating Joule heat may be disposed in any of the heating passage 13 and the raw material passage 22. Alternatively, a whole or part of the reaction tube 20 may be formed of a conductor, and Joule heat may be generated by passing electric current through the reaction tube 20.

The second heating means 30 can be disposed preferably on a downstream side with respect to the position where the raw material fluid F2 from the upstream end 22a is increased in temperature to 800° C., more preferably on a downstream side with respect to the position where the raw material fluid F2 from the upstream end 22a is increased in temperature to 830° C. so that the raw material fluid F2 on the downstream side with respect to the above mentioned position can be heated. The second heating means 30 can be disposed preferably on a downstream side with respect to the discharge port 24 so that the raw material fluid F2 on the downstream side with respect to the discharge port 24 can be heated.

Although FIG. 1 illustrates the case where two second heating means 30 are disposed at different positions in the passage direction of the raw material fluid F2, one second heating means 30 or three or more second heating means 30 may be disposed. In the case where two or more second heating means 30 are used, the second heating means 30 can be disposed at the same position or different positions in the passage direction of the raw material fluid F2.

The raw material fluid F2 is heated by the second heating means 30 in the secondary gasification region 25, and thereby, a secondary gasification reaction occurs to change the gas composition of the raw material fluid F2. In the secondary gasification reaction, the following reaction of Formula 2 proceeds, and as a result, C₂H₄ is decomposed to generate new H₂.

C₂H₄+4H₂O→2CO₂+6H₂ (Formula 2)

In this case, the decomposition of soot and tar also proceeds simultaneously, with the result that production gas of high quality can be obtained.

It is preferred that the secondary gasification temperature (temperature of the raw material fluid F2 heated by the second heating means 30) be higher because the reaction of Formula 2 proceeds at higher speed or higher efficiency and the content of H₂ in the production gas is increased. However, considering the problems regarding, for example, energy efficiency and an increase in cost caused by rendering the reaction tube 20 highly heat resistant, the secondary gasification temperature is preferably 900° C. to 1,100° C., more preferably 950° C. to 1,050° C. The raw material fluid F2 is increased in temperature by the second heating means 30 preferably by 50° C. to 250° C., more preferably by 100° C. to 200° C.

It is considered that the following reactions of Formulas 3 and 4 also proceed during the secondary gasification reaction. However, the reaction speeds thereof are considerably lower than that of the reaction of Formula 2, and hence the influence of the reactions of Formulas 3 and 4 on the composition of production gas is not so great.

CH₄+2H₂O→CO₂+4H₂ (Formula 3)

CO+H₂O→CO₂+H₂ (Formula 4)

As a result of the above-mentioned additional heating performed in the secondary gasification region 25, the production gas F3 having excellent characteristics such as a large content of H₂+CO (preferably 65% or more), a high H₂/CO ratio (preferably 1.5 or more, more preferably 1.8 or more), and/or a small content of C₂H₄ (preferably 3% or less, more preferably 2% or less) can be produced, and in particular, the quality as synthesis gas can be enhanced. Further, a configuration is adopted in which the raw material fluid F2 is increased in temperature by separate heating sources provided on the upstream side and the downstream side (by the heating fluid F1 on the upstream side and by the second heating means 30 on the downstream side), and hence both the increase in treatment amount and the enhancement of quality of the production gas F3 can be achieved even without setting the heating fluid F1 to a very high temperature. Therefore, inconvenience in which the reaction tube 20 is partially increased in temperature excessively is eliminated, and usage of the reaction tube 20 with low heat resistance and long life of the reaction tube 20 can be realized.

The produced production gas F3 is discharged from the downstream end 22b side and used or stored as gas fuel, or used as synthesis gas for liquid fuel such as methanol in a treatment step in a later stage.

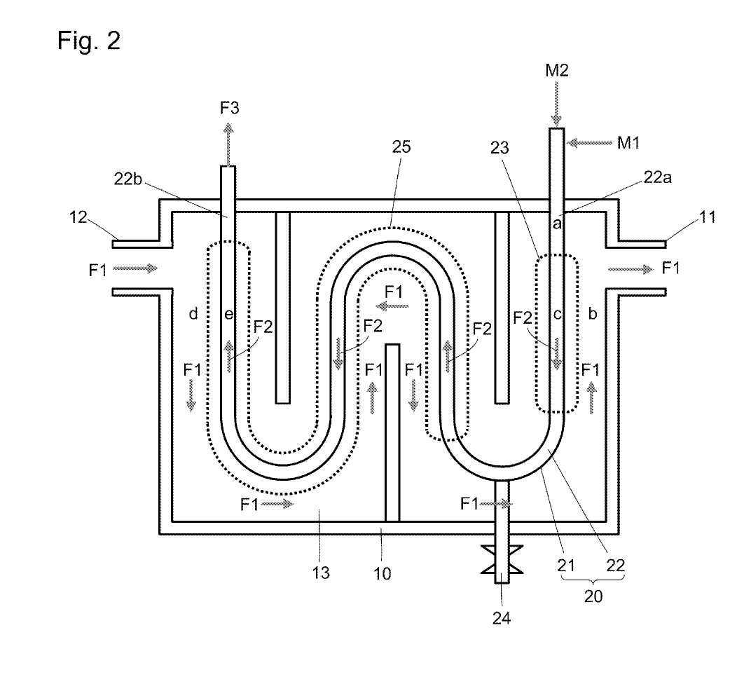

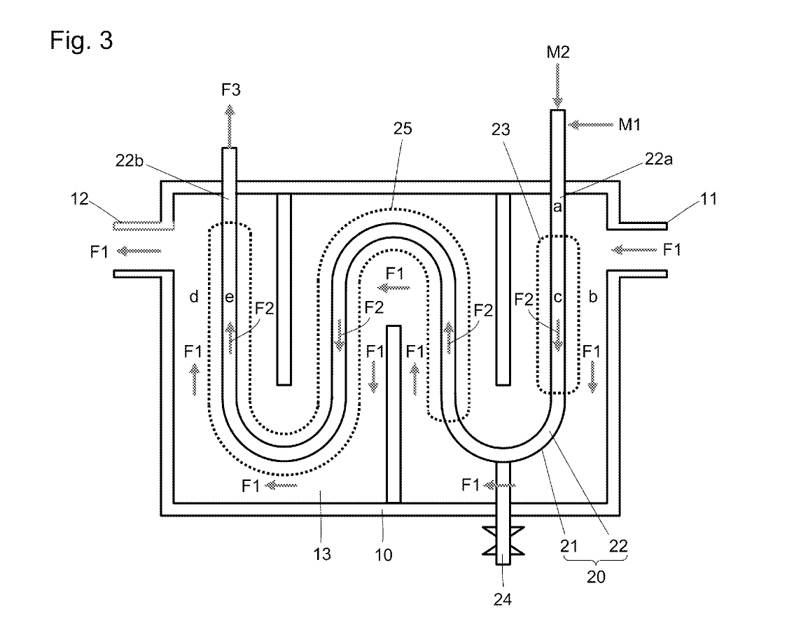

FIGS. 2 and 3 are gas production apparatus of Comparative Examples 1 and 2 used in an effect verification experiment of the present invention, and components corresponding to those of FIG. 1 are denoted with the same reference symbols as those therein.

In Comparative Example 1 (FIG. 2), the passage direction of the heating fluid F1 in the heating passage 13 is opposite to that of FIG. 1. That is, Comparative Example 1 adopts a backward flow system in which the heating fluid F1 is supplied from the downstream side to the upstream side of the raw material fluid F2. In this apparatus, the downstream side of the raw material fluid F2 can be heated to sufficient temperature by the high-temperature heating fluid F1, and hence production gas having a large H₂ content can be produced. However, the temperature of the heating fluid F1 is decreased on the upstream side of the raw material fluid F2, and hence it is difficult to sufficiently increase the temperature of the upstream side of the raw material fluid F2. Consequently, Comparative Example 1 has a defect in that a load cannot be taken (treatment amount of biomass is small).

In the same way as in FIG. 1, Comparative Example 2 (FIG. 3) adopts a forward flow system in which the heating fluid F1 is supplied from the upstream side to the downstream side of the raw material fluid F2. However, Comparative Example 2 is different from Example of FIG. 1 in that the second heating means 30 is not provided (the raw material fluid F2 is not heated by the second heating means 30). In Comparative Example 2, the upstream side of the raw material fluid F2 can be heated to sufficient temperature by the high-temperature heating fluid F1, and hence a load can be taken (large treatment amount of biomass can be realized). However, it is difficult to sufficiently increase the temperature of the downstream side of the raw material fluid F2. Consequently, Comparative Example 2 has a defect in that it is difficult to produce production gas of high quality.

In the apparatus of FIG. 1, the above-mentioned problems in the apparatus of FIGS. 2 and 3 can be solved. That is, the heating fluid F1 is supplied from the upstream side of the raw material fluid F2, and hence the upstream side (primary gasification region 23) of the raw material fluid F2 is heated to sufficient temperature, with the result that a load can be taken (treatment amount of biomass can be increased) easily. Further, the raw material fluid F2 is heated by the second heating means 30 on the downstream side (secondary gasification region 25), and hence production gas of high quality having a large H₂+CO content, a high H₂/CO ratio, and/or a small C₂H₄ content can be produced.

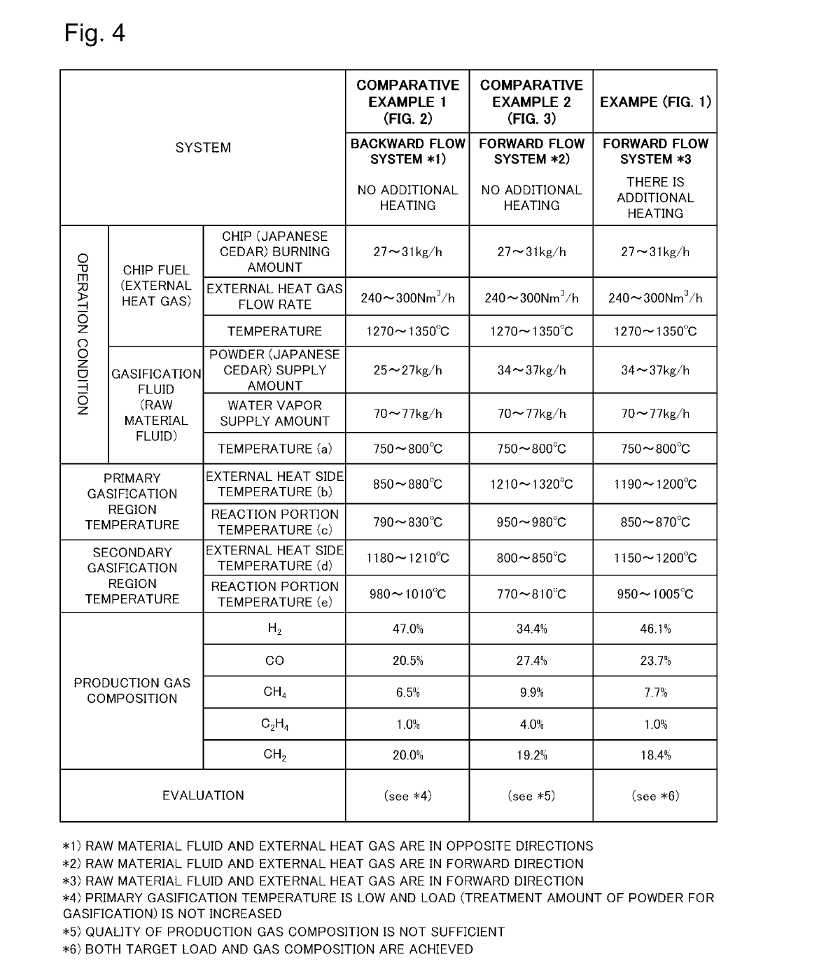

FIG. 4 shows the results of an effect verification experiment using the apparatus of FIGS. 1 to 3. In this experiment, powder having a particle diameter of 3 mm or less obtained by pulverizing Japanese cedar was used as the biomass M1. Further, external heat gas at 1,270° C. to 1,350° C. was generated by burning a chip of 3 mm or more formed by pulverizing the Japanese cedar in a heat gas production furnace. The external heat gas was supplied to the heating passage 13 as the heating fluid F1 in FIGS. 1 to 3. In Example of FIG. 1, the external heat gas was blown into the heating passage 13 from supply ports provided at positions (two positions) denoted with reference numeral 30 to perform additional heating. Temperatures (a) to (e) in FIG. 4 are temperatures measured by thermocouples provided at positions represented by “a” to “e” of FIGS. 1 to 3. Specifically, the temperature (a) corresponds to the temperature of the raw material fluid F2 in the raw material passage 22 at the upstream end 22a. The temperatures (b) and (d) correspond to the temperatures of the external heat gas F1 in the heating passage 13 at the first gasification region 23 and the second gasification region 25. The temperatures (c) and (e) correspond to the temperatures of the raw material fluid F2 in the raw material passage 22 at the first gasification region 23 and the second gasification region 25.

As is understood from FIG. 4, the load was not increased sufficiently (powder (Japanese cedar) supply amount/biomass treatment amount was small) in Comparative Example 1. In Comparative Example 2, the produced production gas is not suitable as synthesis gas for liquid fuel such as methanol because of its small H₂+CO content and low H₂/CO ratio. Further, the content of C₂H₄ is high in Comparative Example 2. In contrast, in Example, the load is sufficient, and the quality of the production gas is high (large H₂+CO content, high H₂/CO ratio, and small C₂H₄ content).

As a modified embodiment of the apparatus and method for producing production gas of FIG. 1, additional heating can be performed by third heating means 30a in the vicinity of the supply port 11 or in the primary gasification region 23 (in particular, on the upstream side). The modified embodiment is useful particularly when the above-mentioned preferred primary gasification temperature cannot be obtained only by the heating by the heating fluid F1. The primary gasification function can be ensured (the temperature of the raw material fluid F2 is increased to the above-mentioned primary gasification temperature) by the additional heating with the third heating means 30a. The third heating means 30a can be heating means same or similar to the second heating means (additional heating means) 30.

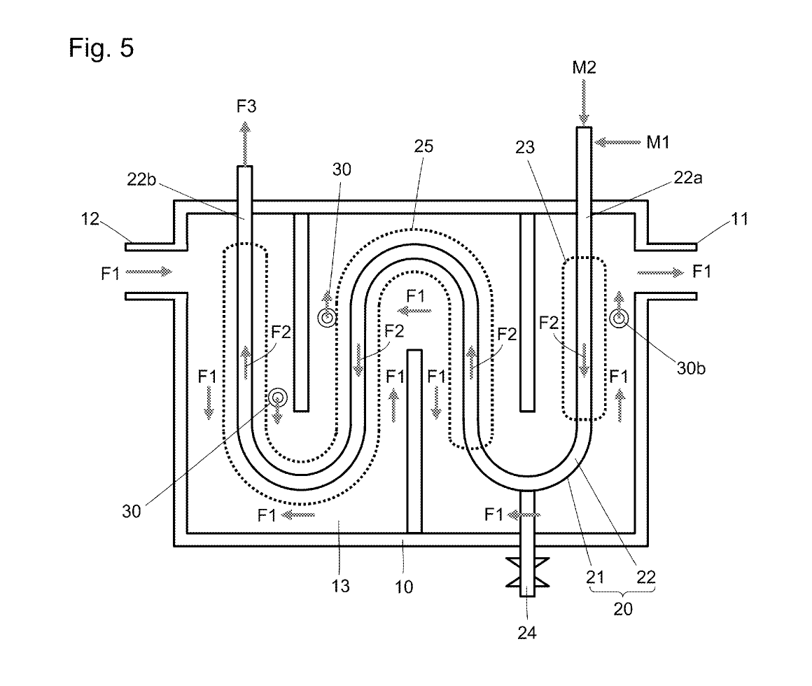

FIG. 5 is an explanatory diagram illustrating an apparatus and method for producing production gas according to another preferred embodiment, and components corresponding to those of FIG. 1 are denoted with the same reference symbols as those therein.

As illustrated in FIG. 5, the embodiment of FIG. 5 is different from that of FIG. 1 in that the embodiment of FIG. 5 adopts a system (backward flow system) in which the passage direction of the heating fluid F1 in the heating passage 13 is opposite to that of the raw material fluid F2 in the raw material passage 22, and in that the embodiment of FIG. 5 includes third heating means 30b at a position (preferably in the first gasification region 23 or in the vicinity thereof, particularly preferably in the vicinity of the discharge port 11) on the downstream side of the heating fluid F1 in the heating passage 13, and the embodiment of FIG. 5 is the same as that of FIG. 1 in the remaining points.

In the apparatus of FIG. 5, a sufficient load can be taken (treatment amount of biomass can be increased) by performing additional heating with the third heating means 30b on the upstream side of the raw material fluid F2. Then, on the downstream side (second gasification region 25) of the raw material gas F2, the raw material gas F2 is increased in temperature effectively by the heating fluid F1 with higher-temperature and the second heating means 30, with result that production gas of high quality having a large H₂+CO content, a high H₂/CO ratio, and/or a small C₂H₄ content can be produced.

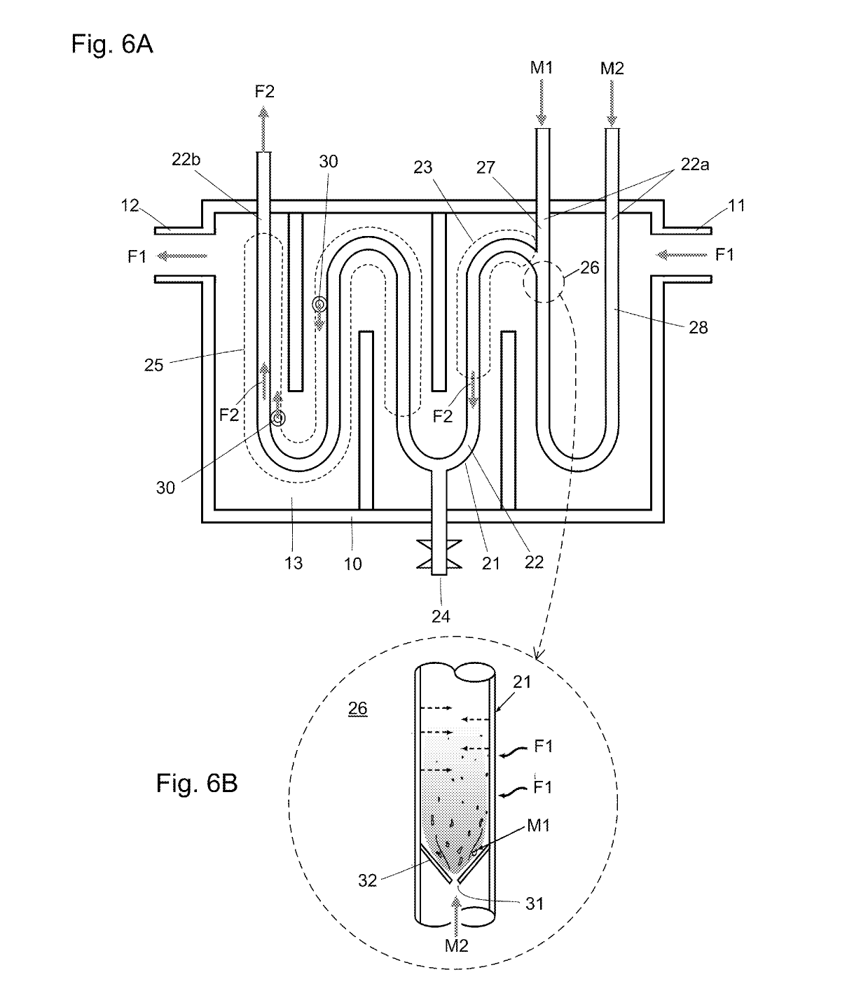

FIG. 6A is an explanatory diagram illustrating an apparatus and method for producing production gas according to another preferred embodiment, and components corresponding to those of FIG. 1 are denoted with the same reference symbols as those therein.

As illustrated in FIG. 6A, this embodiment has the same configuration as that of FIG. 1 except that the raw material passage 22 is divided into first and second branch tubes 27, 28 on the upstream end 22a side with respect to a confluence point 26, the biomass M1 is introduced from the first branch tube 27, and the reaction water M2 is introduced from the second branch tube 28. Thus, the reaction water M2 is mixed with the biomass M1 in a state of being preliminarily heated by the heating fluid F1.

FIG. 6B is an explanatory diagram illustrating a detail of the confluence point 26.

As illustrated in FIG. 6B, a conical (inverted cone) rectifier 32 having an opening 31 at the center is provided on an inner side of the reaction tube wall 21 of the confluence point 26, and the high-temperature reaction water M2 from the second branch tube 28 is blown into the confluence point 26 through the opening 31, with the result that the reaction water M2 is mixed with the biomass M1 supplied from the first branch tube 27 while the biomass M1 is being floated. The raw material fluid F2 formed of the biomass M1 and the reaction water M2 is heated to be gasified with heat from the heating fluid F1 in the primary gasification region 23 which is a region having a predetermined length on the downstream side from the confluence point 26 (primary gasification reaction). The heating fluid F1 gasified by the first gasification reaction is additionally heated by the second heating means 30 in the secondary gasification region 25 on the downstream side with respect to the primary gasification region 23 to cause the second gasification reaction, with result that production gas can be enhanced in quality.

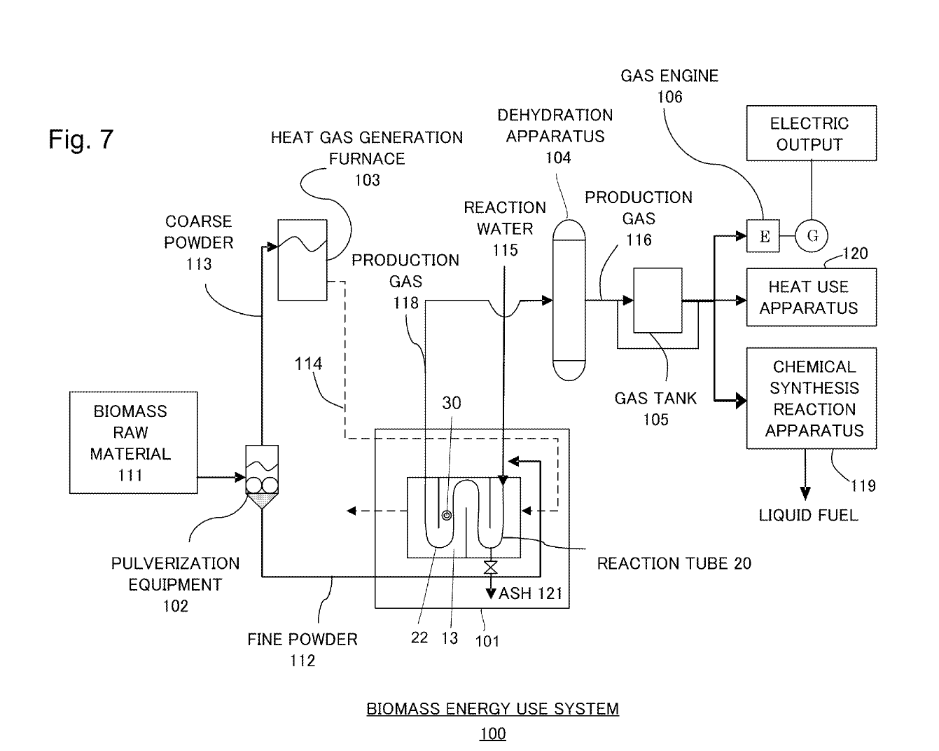

FIG. 7 is an explanatory diagram illustrating an illustrative biomass energy use system 100 including a gas production apparatus 101.

The system 100 includes pulverization equipment 102 for pulverizing a biomass raw material 111. The pulverizing equipment 102 receives the biomass raw material 111 and pulverizes the biomass raw material 111 into fine powder having an average particle diameter of 3 mm or less, preferably 1 mm or less and fractionates and separately discharges the fine powder as biomass fine powder 112 having an average particle diameter of 3 mm or less and biomass coarse powder 113 having an average particle diameter of more than 3 mm. The pulverization equipment 102 can be configured by combining a pulverizer with an impact mill. The biomass coarse powder or chips 113 are supplied to a heat gas generation furnace 103, and the biomass coarse powder or chips 113 are burnt with a combustion enhancing agent such as air at about 1,200 to 1,350° C. to generate high-temperature external heat gas 114.

The gas production apparatus 101 can be configured in the same way as in the gas production apparatus of FIGS. 1, 5, and 6. The biomass fine powder 112 supplied from the pulverization equipment 102 is guided to the raw material passage 22 of the reaction tube 20 together with reaction water (water vapor) 115 supplied separately, and the external heat gas 114 supplied from the heat gas generation furnace 103 is guided to the heating passage 13. The external heat gas 114 heats a raw material fluid formed of the biomass fine powder 112 and the reaction water 115 in the raw material passage 22 through the reaction tube wall of the raw material passage 22 to cause the primary gasification reaction in the primary gasification region 23. The gas produced by the primary gasification reaction is additionally heated by the second heating means 30 in the secondary gasification region on the downstream side with respect to the primary gasification region, with the result that production gas 118 of high quality having a large H₂+CO content, a high H₂/CO ratio, and/or a small C₂H₄ content is produced by the secondary gasification reaction.

The system 100 can further include a dehydration apparatus 104, a gas tank 105, a gas engine 106, a chemical synthesis reaction apparatus 119, heat use equipment 120, and the like.

The dehydration apparatus 104 has a structure containing a cooling heat transfer surface capable of condensing and removing high-boiling substances such as moisture, a sulfur compound (H₂S, etc.), and a chlorine content (HCl) in gas introduced into the apparatus. The gas tank 105 has a structure capable of storing production gas by any system such as a water seal system.

Product gas 116, 118 is used in the gas engine 106, the chemical synthesis reaction apparatus 119, the heat use equipment 120, and the like. The gas engine 106 generates power through use of the production gas 118 as fuel, the chemical synthesis reaction apparatus 119 synthesizes liquid fuel such as methanol by a procedure such as FT synthesis, and the heat use equipment 120 uses combustion heat of the production gas for heating or the like.

The preferred embodiments are described above. However, the invention recited in the attached claims is not limited to the above-mentioned embodiments.

For example, in the above-mentioned embodiments, the case where the entire raw material passage 22 extending from the upstream end 22a to the downstream end 22b is accommodated in the heating passage 13 is shown. For example, the following is also possible: only a predetermined portion (portion including the primary gasification region 23) on the upstream side of the raw material passage 22 is disposed in the heating passage 13 so that only this portion is heated by the heating fluid F1, and the heating by the second heating means 30 is performed in a space separate from the heating passage 13.

Further, in the above-mentioned embodiments, the S-shaped heating passage 13 and raw material passage 22 are shown. However, one or both of the heating passage 13 and the raw material passage 22 can also be formed in any other shapes such as a straight shape and a spiral shape. The above-mentioned additional heating system can also be applied to a backward flow system.

### EXPLANATION OF REFERENCES

10 . . . heating furnace
11 . . . supply port
12 . . . discharge port
13 . . . heating passage
20 . . . reaction tube
21 . . . reaction tube wall
22 . . . raw material passage
23 . . . primary gasification region
24 . . . discharge port
25 . . . secondary gasification region
26 . . . confluence point
27 . . . first branch tube
28 . . . second branch tube
30 . . . second heating means
31 . . . opening
32 . . . rectifier
M1 . . . biomass
M2 . . . reaction water
F1 . . . heating fluid
F2 . . . raw material fluid
F3 . . . production gas
100 . . . biomass energy use system
101 . . . gas production apparatus
102 . . . pulverization equipment
103 . . . heat gas generation furnace
104 . . . dehydration apparatus
105 . . . gas tank
106 . . . gas engine
111 . . . biomass raw material
112 . . . biomass fine powder
113 . . . biomass coarse powder
114 . . . external heat gas
115 . . . reaction water
118 . . . production gas
119 . . . chemical synthesis reaction apparatus
120 . . . heat use equipment

1. A method for producing production gas, comprising:
supplying a raw material fluid containing biomass from an upstream end side to a downstream end side in a raw material passage separated from outside by a reaction tube wall; and
heating the raw material fluid in the raw material passage by first heating means through the reaction tube wall from outside of the raw material passage,
the raw material passage including a first gasification region for causing a first gasification reaction in which at least part of the biomass is gasified by the heating by the first heating means, and a second gasification region positioned on the downstream end side with respect to the first gasification region,
wherein, in the second gasification region, the raw material fluid is increased in temperature to 900° C. to 1,100° C. by subjecting the raw material fluid to additional heating by second heating means.

2. A method for producing production gas according to claim 1, wherein the first heating means comprises a heating fluid to be supplied from the upstream end side to the downstream end side in a heating passage separated from the raw material passage by the reaction tube wall.

3. A method for producing production gas according to claim 1, wherein the raw material fluid is subjected to additional heating by third heating means in the first gasification region.

4. A method for producing production gas according to claim 2, wherein the heating fluid comprises gas increased in temperature by burning a combustible.

5. A method for producing production gas according to claim 2, wherein the first gasification region and the second gasification region are contained in the heating passage.

6. A method for producing production gas according to claim 1, wherein the additional heating is performed in a plurality of stages at a plurality of positions in the second gasification region.

7. A method for producing production gas according to claim 1, wherein a reaction in which a hydrocarbon is decomposed to generate hydrogen proceeds at higher speed or higher efficiency in the second gasification region than in the first gasification region.

8. A method for producing production gas according to claim 1, wherein the raw material fluid is heated to 800° C. to 1,000° C. by the first heating means in the first gasification region.

9. (canceled)

10. A method for producing production gas according to claim 1, wherein the additional heating is performed on the downstream end side with respect to a position where the raw material fluid is increased in temperature to 800° C. or more by the heating by the first heating means.

11. A method for producing production gas according to claim 1, wherein the raw material passage includes a discharge port for discharging ash, and the additional heating is performed on the downstream end side with respect to the discharge port.

12. A method for producing production gas according to claim 1, wherein the additional heating is performed by burning fuel in the heating passage.

13. A method for producing production gas according to claim 1, wherein the additional heating is performed by introducing gas at a predetermined temperature or higher to the heating passage.

14. A method for producing production gas according to claim 1, wherein the additional heating is performed by electric heating.

15. A method for producing production gas according to claim 1, wherein the raw material fluid is increased in temperature by 100° C. to 200° C. by the additional heating.

16. A method for producing production gas, comprising:
supplying a raw material fluid containing biomass from an upstream end side to a downstream end side in a raw material passage;
supplying a heating fluid from the upstream end side to the downstream end side along the raw material passage in a heating passage separated from the raw material passage by a reaction tube wall; and
heating the raw material fluid by supplying heat of the heating fluid to the raw material fluid in the raw material passage through the reaction tube wall,
wherein the raw material fluid is increased in temperature to 800° C. to 1,000° C. with heat from the heating fluid in a predetermined site of the raw material passage, and
the raw material fluid is increased in temperature to 900° C. to 1,100° C. by performing additional heating through use of second heating means on a downstream side with respect to the predetermined site.

17. An apparatus for producing production gas, comprising:
a raw material passage which is separated from outside by a reaction tube wall, a raw material fluid containing biomass being supplied from an upstream end side to a downstream end side; and
first heating means,
wherein the raw material fluid in the raw material passage is heated by the first heating means through the reaction tube wall from outside of the raw material passage,
the raw material passage includes a first gasification region for causing a first gasification reaction in which at least part of the biomass is gasified by the heating by the first heating means, and a second gasification region positioned on the downstream end side with respect to the first gasification region, and
the apparatus further comprises second heating means for increasing a temperature of the raw material fluid to 900° C. to 1,100° C. by performing additional heating of the raw material fluid in the second gasification region.
